(19) United States
(12) Patent Application Publication
(10) Pub. No.: US 2024/0047146 A1
(43) Pub. Date: Feb. 8, 2024

(54) Method for Synthesizing High-Rate Capability Cement-Carbon Supercapacitor

(71) Applicant: Massachusetts Institute of Technology, Cambridge, MA (US)

(72) Inventors: Nicolas Chanut, Cambridge, MA (US); Yunguang Zhu, San Diego, CA (US); Yang Shao-Horn, Newton, MA (US); Franz-Josef Ulm, Cambridge, MA (US)

(21) Appl. No.: 18/365,677

(22) Filed: Aug. 4, 2023

Related U.S. Application Data
(60) Provisional application No. 63/370,618, filed on Aug. 5, 2022.

(51) Int. Cl. H01G 11/24; H01G 11/52; H01G 11/08; H02J 7/34; H01G 11/38; C04B 38/08; H02J 7/00

(52) U.S. Cl. CPC H01G 11/24; H01G 11/52; H01G 11/08; H02J 7/345; H01G 11/38; C04B 38/08; H02J 7/0068; H01G 11/54

(57) ABSTRACT

A structural supercapacitor, and methods of manufacturing, composed of a conductive composite is described herein. An embodiment of the composite has a controllable transport porosity, that enables transport of electrical charge, via electrolyte solution, to a distributed conductive network within the composite. The distributed conductive network has a controllable storage porosity that enables the storage of electrical charge. The conductive composite can be used in a variety of different fields of use, including, for example, a structural super-capacitor as an energy solution for autonomous housing and other buildings, a heated cement for pavement de-icing or house basement insulation against capillary rise, a protection of concrete against freeze-thaw (FT) or alkali silica reaction (ASR) or other crystallization degradation processes, and as a conductive cable, wire, or concrete trace.

### RELATED APPLICATION

This application claims the benefit of U.S. Provisional Application No. 63/370,618, filed on Aug. 5, 2022. The entire teachings of the above application are incorporated herein by reference.

### BACKGROUND

There is no material that can replace cement in the foreseeable future to meet societies' needs for housing, shelter and infrastructure. Nevertheless, cement faces an uncertain future due to a non-negligible ecological footprint that amounts to 5-10% of the worldwide CO₂ production. However, thanks to breakthroughs in science and engineering, cement has a novel potential to contribute to a sustainable development encompassing economic growth and social progress while minimizing the ecological footprint. A possible contribution for cement to service in sustainable development is the ability for cement to act as both a construction material and an energy storage device.

### SUMMARY

In particular, if a cement, or equivalent, composite can also function as a capacitor, it would be able to store and distribute energy while also acting in its traditional role as building material. A need exists for a high-rate capacity cement-carbon composite that can store sufficient amounts of electrical energy and discharge the stored energy at a significate rate. Such a composite would provide a scalable material solution for energy storage in supercapacitors constructed from readily available material precursors that can be locally sourced from virtually anywhere on the planet, namely cement, water and carbon black.

Embodiments of the invention include a method of synthesizing high-rate capability cement-carbon supercapacitors enabled through synergistically leveraging a dual porosity characteristic in created cement-carbon composite electrodes, also referred to herein as a cement-based material. The dual porosity system is composed of (1) the cement's porosity acting as a reservoir/transport path for an electrolyte (referred to herein as “transport porosity”), and (2) carbon's porosity, acting as active porosity for energy storage, either in or in close vicinity of the porosity (referred to herein as “storage porosity”) due to the electron conductive nature of carbon. The transport porosity optimizes diffusion of the electrolyte to the storage porosity and can be fine-tuned through engineering a hydration process of the cement-based material. In its turn, the storage porosity is fine-tuned through the choice of the carbon material, preferably with a high specific surface area, and its distribution in the composite. The synergy of these two elements is at the core of the method disclosed herein for synthesizing high-rate capability cement-carbon composite supercapacitors with controllable capacitance and electrical charge/discharge rate.

Embodiments of the invention may include a structural supercapacitor comprising a composite, the composite composed of i) an electrically conductive percolated network hosting a porosity for charge storage and ii) a non-electrically conductive structural matrix, the non-electrically conductive structural matrix having a controlled transport porosity configured to host an electrolyte solution.

In some embodiments, the composite is a product of chemical reactions of a chemically reactive mixture and wherein the controlled transport porosity is a function of an amount of a fluid in the chemically reactive mixture. The fluid may be a water-based solution. Additionally, in the fluid, the chemically reactive mixture may exceed a level of the fluid required for formation of the non-electrically conductive structural matrix.

The composite may further include an electrolyte solution within the controlled transport porosity at a level of saturation. The composite may be an electrically conductive cement composite. In some embodiments, the structural supercapacitor further comprises at least one of sand, gravel, stones or other conductive or non-conductive aggregates mixed with the composite. The structural supercapacitor may be produced by additive manufacturing.

The electrically conductive percolated network hosting a porosity may include porous electrically conductive particles. In such embodiments, the porous electrically conductive particles can be selected from a group having an accessible specific surface, including: carbon black nanoparticles, activated carbon, carbon nanotubes, mXene, a metal-organic framework, or a mixture of electrically-conductive particles.

The structural supercapacitor may also comprise a non-conductive separator separating a first electrode structure and a second electrode structure, the first and second electrode structures defined by the composite, the first and second electrode structures enabling storage and retrieval of energy to and from the structural supercapacitor. In such embodiments the first and second electrode structure may be oriented in an arrangement configured for use to charge/discharge energy into/out of structural and/or non-structural elements in buildings, road and transportation infrastructure, foundations, and other underground structures.

Embodiments of the invention may include a method of manufacturing a structural supercapacitor. An example method may comprise creating a chemically reactive mixture including a non-conductive binder, porous electrically conductive particles, and fluid, and producing, by means of chemical reactions of the chemically reactive mixture, a composite that includes an electrically conductive percolated network hosting a porosity for charge storage and a non-electrically conductive structural matrix, the non-electrically conductive structural matrix having a controlled transport porosity configured to host an electrolyte solution.

Producing the composite may include controlling an amount of fluid applied to the chemically reactive mixture to create the controlled transport porosity. In such embodiments, controlling the amount of the fluid in the chemically reactive mixture may include adding an amount that exceeds a level that is required for formation of the non-electrically conductive structural matrix. Alternatively, in such embodiments, an electrical charge/discharge rate of the composite may be dependent upon the controlled transport porosity.

In some embodiments of the method, the method may further comprise saturating the controlled transport porosity with the electrolyte solution to produce a saturated electrolyte transport porosity. In such embodiments, the saturated electrolyte solution can be in contact with the electrically conductive percolated network.

The fluid may be a water-based solution. The non-conductive binder can be hydraulic cement. The non-conductive binder can also include supplementary cementitious materials (SCM) selected from a group consisting of: fly ash, silica fume, slags, and other soluble siliceous, aluminosiliceous, or calcium aluminosiliceous powders used as partial replacements of clinker in cements or as partial replacements of Portland cement in concrete mixtures; and superplasticizers. The porous electrically conductive particles may be selected from a group having an accessible specific surface, the group consisting of: carbon black nanoparticles, activated carbon, carbon nanotubes, mXene, a metal-organic framework, or a mix of electrically-conductive particles.

In some embodiments of the method, the porous electrically-conductive particles are selected from a group having an accessible specific surface, the group consisting of: carbon black nanoparticles, activated carbon, carbon nanotubes, mXene, a metal-organic framework, or a mix of electrically-conductive particles. Additionally, the non-electrically conductive structural matrix can be configured to support a mechanical load.

The method may further include forming a supercapacitor having a first electrode structure and a second electrode structure, the first and second electrode structures including the composite and separated by a non-conductive separator, the supercapacitor configured to provide a means of storing and retrieving energy via the first and the second electrode structures.

Embodiments of the invention also include a chemically reactive mixture. The mixture comprising a non-conductive binder and porous electrically conductive particles and configured to produce, by means of chemical reactions induced by the addition of a fluid, a composite that includes an electrically conductive percolated network hosting a porosity for charge storage and a non-electrically conductive structural matrix, the non-electrically conductive structural matrix having a controlled transport porosity configured to host an electrolyte solution.

Embodiments of the invention further include a method of storing electrical charge using a structural supercapacitor. The method comprises receiving, from a source external to a composite, electrical charge by an electrolyte solution, the electrolyte solution hosted in a controlled transport porosity of a non-electrically conductive structural matrix of the composite. The method continues by transferring, from the electrolyte solution, the received electrical charge to an electrically conductive percolated network hosting a porosity for charge storage within the composite and storing the electrical charge in the porosity for charge storage.

Embodiments of the invention further include a method of discharging electrical charge using a structural supercapacitor. The method comprises transferring electrical charge stored in or in the close vicinity of a porosity for charge storage hosted by an electrically conductive percolated network within a composite. The method continues by receiving the transferred electrical charge by an electrolyte solution, the electrolyte solution hosted in a controlled transport porosity of a non-electrically conductive structural matrix of a composite and discharging, from the electrolyte solution, the electrical charge to a receiver external to the composite.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a picture of a symmetrical arrangement of two electrodes, comprised of a cement composite created by embodiments of the invention.

FIG. 1B is a picture of a sample symmetrical arrangement of two electrodes within a closed cell.

FIG. 1C is a picture of a device able to apply pressure applied to a sample symmetrical arrangement of two electrodes enclosed in a closed cell.

FIG. 2A is a set of graphs of cyclic voltammetry (CV) curves recorded at different prescribed scan rates for a sample symmetrical arrangement of two electrodes, comprised of the composite created by embodiments of the invention with a water-to-cement ratio of 0.8 and a water-to-cement ratio of 1.4.

FIG. 2B is a graph of an areal capacitance determination as a function of discharge rate for the sample's cyclic voltammetry (CV) curves shown in FIG. 2A.

FIG. 2C shows the results of a galvanostatic charge-discharge (GCD) test on a sample symmetrical arrangement of two electrodes, comprised of a cement composite created by embodiments of the invention with a water-to-cement ratio of 0.8.

FIG. 2D is a graph of capacitance retention and coulombic efficiency during charge-discharge cycles of a sample symmetrical arrangement of two electrodes, comprised of the cement composite created by embodiments of the invention with a water-to-cement ratio of 0.8.

FIG. 2E is a set of graphs showing the results of the capacitance per carbon black particle mass for two sets of electrodes comprised of the cement composite created by embodiments of the invention.

FIG. 2F is a graph that shows the relationship between hardness and capacitance for electrodes composed of the cement composite created by embodiments of the invention.

FIG. 3A is a graph of cyclic voltammetry (CV) curves of three composites created by embodiments of the invention with water-to-cement ratios of 0.42, 0.6, and 0.8 at a scan rate of 20 mV/s.

FIG. 3B is a graph of cyclic voltammetry (CV) curves of three cement composites created by embodiments of the invention with water-to-cement ratios of 0.42, 0.6, and 0.8 at a scan rate of 500 mV/s.

FIG. 3C is a graph of the derived areal capacitance values as a function of scan rate for three composites created by embodiments of the invention with water-to-cement ratios of 0.42, 0.6, and 0.8.

FIG. 3D is a graph of carbon gravimetric capacitance as a function of scan rate for three composites created by embodiments of the invention with water-to-cement ratios of 0.42, 0.6, and 0.8.

FIG. 4 is a graph of the capacitance as a function of carbon surface area of three sample cement composites created by embodiments of the invention utilizing different carbon particles.

FIG. 5 is a graph of the rate-independent capacitance of eight different electrodes comprised of cement material, created using embodiments of the invention, showing the intensive nature of the energy storage capacity of created electrode systems.

FIG. 6 is a graph of the rate dependance capacitance of eight different electrodes comprised of cement material, created using embodiments, of the invention scaled along the horizontal axis by means of the classical dimensionless diffusion variable.

### DETAILED DESCRIPTION

A description of example embodiments follows.

Embodiments of the invention include a method of manufacturing a cement composite (“composite”) and the resulting composite that is able act as both a structural building material, e.g., hydraulic cement, and a conductive material able to store and distribute energy. The composite can provide alternative energy storage solutions to prior art battery technologies using inexpensive and readily available material precursors able to be sourced at a global scale. The composite is capable of forming a high-rate capability supercapacitors used to store and distribute energy in contrast to the chemical energy conversion used for energy storage by batteries.

High-rate capability supercapacitors rely on three elements: (i) an electron conductive network for charging the electrodes; (ii) a storage porosity of high specific surface area onto which an oppositely charged surface layer adsorbs; and (iii) a reservoir porosity for charge transport by ion-diffusion through a saturating electrolyte to or away from the surface layer.

The composite is a result of a chemically reactive mixture that creates a non-electrically conductive porous material that acts as structural support matrix and an insulator that contains, within its pores, an electrically conductive network, this provides element (iii) a reservoir porosity for charge transport by ion-diffusion through a saturating electrolyte to or away from the surface layer needed to create a supercapacitor. The porosity of the non-electrically conductive porous material is defined as the composite's “transport porosity.” The electrically conductive network is distributed throughout the non-electrically conductive porous material and includes particles that have a porosity that enables storage of electrical charge. The porosity of the electrically conductive network is defined as the composite's “storage porosity;” this provides element (ii) a storage porosity of high specific surface area onto which an oppositely charged surface layer adsorbs needed to create a supercapacitor. Finally, the non-electrically conductive porous material also hosts an electrolyte solution within its pores that connects and enables the deposition and/or withdrawal of electrical charge from the electrically conductive network, which provides element (i) an electron conductive network for charging the electrodes needed to create a supercapacitor.

As used herein and in the accompanying claims, a “electrically conductive percolated network” means a network formed by continuous connection of conductive particles that have percolated a capillary pore network of a composite to a sufficient degree to make the composite electrically conductive. The claims, a “electrically conductive percolated network of conductive particles can, but need not, substantially or completely fill the porosity of the capillary pore network of the composite. A capillary pore network within a composite, for example a cement composite, can, for example, include pores between about 5 nanometers and about 1 micron in size.

As used herein and in the accompanying claim, a “non-electrically conductive structural matrix” means the solid that is formed by the chemical reaction, such as the solid that is formed by the hydration reactions of hydraulic cement with water that acts as a non-conductive insulator and is capable of supporting a structural load. Additionally, the non-electrically conductive structural matrix has a porosity (transport porosity) that enables it to contain the electrically conductive percolated network and an electrolyte solution.

Embodiments of the invention include superconductors and electrical conductors that include at least one electrode, in various arrangements, made of the disclosed composite. In addition, the composite can be used in a variety of different possible fields of use, including, for example: a structural super-capacitor as an energy solution for autonomous housing and other buildings; a heated cement for pavement deicing or house basement insulation against capillary rise; a protection of concrete against freeze-thaw (FT) or alkali silica reaction (ASR) or other crystallization degradation processes; and as a conductive cable, wire or concrete trace.

The transport porosity of the composite may be large enough to allow for sufficient distribution of the electrically conductive network as well as the connection of that network to the stored electrolyte solution, providing both sufficient means of storing charge and accessing that stored charge. However, the transport porosity cannot be so large so that the non-electrically conductive porous material loses strength and can no longer carry any load as a safe structural and non-structural material. The transport porosity of the resulting composite is controllable based upon the ratio of the components of the chemically reactive mixture that produces the composite. Therefore, embodiments of the invention can ensure that the composite has the required properties to form a supercapacitor while still being a functional building material.

Embodiments of the invention are based on a discovery that a supercapacitor can be constructed of a conductive carbon-cement composite formed by the hydration process of a mixture comprising a mineral precursor, such as hydraulic cement, that can react with water to form cement hydrates, which, as a solid, is an insulator and carbon particles, that form a network within the insulator able to store and discharge electrical energy. The network is formed by a continuous connection of carbon particles that have percolated throughout the capillary pore network of the hydrated cement, or other porous insulator, to a sufficient degree to make the composite electrically conductive. The network of carbon particles can, but need not, substantially or completely fill the porosity of the capillary pore network of the cement. A capillary pore network within a cement composite can, for example, include pores between about 5 nanometers and about 1 micron in size. While, the embodiments presented herein disclose use of a cement mineral precursor, it should be clear to one skilled in the art that other mineral precursors that undergo a hydration process thereby leaving behind a sizeable porosity, and act as a non-conductive binder (such as in swelling clay) could be used by alternative embodiments of the invention, provided that an electron-conducting network of conductive particles through the insulating hydrated phase can be established.

Similarly, the embodiments presented herein disclose a use of water, or water-based solutions, as a hydrating fluid, but it should be clear to one skilled in the art that other fluids may be utilized.

In some non-limiting embodiments, the resulting carbon-cement composite may comprise between about 2% by weight and about 15% by weight of the carbon particles with respect to the hydraulic cement in the total initial mix comprising the hydraulic cement, the water, and the carbon particles. The composite may utilize a water-to-cement ratio between about 0.5 and about 1.4. The carbon particles can be a carbon material comprising a dominating population of carbon atoms engaged in sp²-hybridization (trigonal hybridization). The carbon particles may be nanoparticles and that can define a pore size of less than about 10 nanometer. In other embodiments, The carbon particles may be nanoparticles and that can define a pore size of less than about 1 nanometer. The carbon particles may comprise at least one of: Vulcan carbon black, Ketj en carbon black, PBX carbon black, and an activated porous carbon, such as AX-21 or a saccharose coke; and can define a pore size of less than about 1 nanometer. The PBX carbon black can, for example, be PBX® 55 carbon black, sold by Cabot Corporation of Boston, Massachusetts, U.S.A.

As used herein, “hydraulic cement” is a cement that sets in the presence of water and forms a water-resistant product. Examples include Portland cement, Portland cement blends, and calcium sulfoaluminate cements. However, the resulting insulator cement will have a transport porosity that enables fluidic transport through the solid insulator. In other words, the formed cement hydrate will have voids through which fluid can travel or be stored within.

As used herein, “Portland cement” is defined in accordance with ASTM Standard C150, the entire teachings of which are incorporated herein by reference. More particularly, “Portland cement” as used herein refers to hydraulic cement (i.e., cement that not only hardens by reacting with water but also forms a water-resistant product) produced by pulverizing “clinkers” which consist essentially of hydraulic calcium silicates, usually containing one or more forms of calcium sulphate.

The mineral precursor utilized by embodiments of the invention, may be a hydraulic cement and can include Portland cement, and the resulting composite can include between about 50% by weight and about 70% by weight of Portland cement, such as about 60% by weight of Portland cement, with respect to a total initial mix comprising the hydraulic cement, an optional dispersing agent, the water, and the carbon particles. The network of carbon particles can substantially fill a capillary pore network of the cement composite. The capillary pore network can include pores between about 5 nanometers and about 1 micron in size. The electrically conductive cement composite can comprise a greater than 90 percent connected percolating pore network that hosts the carbon particles that form a continuous percolating network of carbon particles able to store, receive and discharge electrical charge. The carbon particles can have a specific surface area less than about 3000 m²/g, and in some embodiments a specific surface area less than about 300 m²/g.

Additionally, an electrically conductive mortar can be made that includes fine aggregate and any of the electrically conductive cement composites taught or contemplated herein. An electrically conductive concrete can also be made that includes sand, gravel aggregates, or other conductive or non-conductive aggregates, and any of the electrically conductive composites taught or contemplated herein. The aggregates, if added, may be of any shape or size. Other embodiment mays also include an addition of supplementary cementitious materials (SCM), such as fly ash, silica fume, slags, agents to control setting of the cement, such as superplasticizers, to the mineral precursor, and other soluble siliceous, aluminosiliceous, or calcium aluminosiliceous powders used as partial replacements of clinker in cements or as partial replacements of Portland cement in concrete mixtures; and superplastizers.

A high-rate capability cement-carbon supercapacitor in accordance with some embodiments of the present invention has a target transport porosity that is (1) large enough to accommodate an electrolyte solution, and (2) fully connected so that electrolyte can reach the carbon particles distributed in the material to form an electron conductive network (sometimes referred to as “a volumetric wire” or “electrically conductive network”).

In ordinary Portland cement materials (i.e., without carbon particles), porosity is created by means of modulating the hydration process through, e.g., the water-to-cement mass ratio. More specifically, for a full hydration of the cement clinker, a specific amount of water is required, which is so-called stoichiometric limit defined by stoichiometry (mass balance) of chemical reactants (clinker and water) and chemical products (hydration products). For ordinary Portland cement-based materials, this stoichiometric limit translates into a water-to-cement mass ratio (“W/C”)=0.42. Hence, a cement-based material prepared at a W/C ratio greater than 0.42 entails a residual water content at the end of the hydration process, i.e., water not consumed in the hydration process. In embodiments of invention, this stoichiometric limit equally applies to carbon-cement composites. The residual cement porosity created by water in excess of the stoichiometric limit plays a role of the transport porosity in the electrodes of supercapacitors. This transport porosity is further connected by the so-called gel porosity of the hydration products, which is much smaller in size; typically, in the 10s of nanometers, compared to the micrometer-sized porosity that dominates the transport porosity.

Example embodiments of the invention utilize water-to-cement (mass) ratios “W/C” of 0.42, 0.6 and 0.8. According to classical tools of cement science, these W/C ratios translate into a residual porosity of ˜0, 19, and 34 vol % of the cement hydration products, as determined from the Powers-Brownyard hydration model. The capacitance for the three example W/C ratios is compared later in this disclosure.

Electrical energy (transported through the electrolyte) is stored on large surface areas of the carbon particles that form the electrically conductive network, most likely in a double layer at an interface between the surface of the conducting carbon particle and the electrolytic solution saturating the transport porosity. Therefore, the energy storage capacity depends on the surface area of the carbon particles. While this is well known for typical carbon-based (only) supercapacitors with, e.g., hierarchical porosity structures, embodiments of the invention utilize this principle in a novel way for the created carbon-cement composites, where the cement porosity acts as the transport porosity, whereas the carbon porosity and its surface in combination acts as storage porosity. Otherwise said, embodiments of the invention use a combination of storage porosity of the particles comprising the electrically conductive network with an engineered and controllable transport porosity of the non-electrically conductive porous material, e.g., cement-hydration matrix, to provide the means to generate high-rate capability structural supercapacitors.

Example embodiments of the invention utilize three types of carbon black particles of different surface area, namely PBX, Vulcan, and Ketj en Black, which exhibit three different surface areas, namely 50 m²/g; 240 m²/g and 1,300 m²/g determined from Brunauer-Emmett-Teller, BET, measurements. Pore size, volume, and surface measurements of the three different carbon black particles, which differ primarily in the specific surface (BET or Non-local density functional theory, NLDFT, methods were used for the determination of the specific surface areas) are displayed below in Table 1. The results have been obtained based on Argon adsorption at 87K (for the BET); and Argon adsorption at 87K and CO2 adsorption at 273K using a dual-fit method.

TABLE 1

| | BET (Ar) | NLDFT (Ar/CO₂) | | | | |
|---|---|---|---|---|---|---|
| | S^{BET} | S_{NLDET} | Sub-nanopores | Micropores | Mesopores | |
| Sample | (m² · g⁻¹) | (m² · g⁻¹) | (m² · g⁻¹) | (m² · g⁻¹) | (m² · g⁻¹) | Peak (Å) |
| PBX 55 | 52 | 54 | 18 (33.3%) | 27 (50%) | 27 (50%) | 8 |
| Vulcan | 241 | 241 | 138 (57%) | 188 (78%) | 53 (22%) | 6-7 |
| Ketjen | 1307 | 1162 | 404 (35%) | 665 (57%) | 497 (43%) | 7 |

In order to translate the specific surface of the carbon black powder into the actual specific surface available for energy storage in cement-carbon composites, the theoretical specific surface was determined by multiplying the BET specific surface by the actual weight of the carbon black in the sample. This calculation assumes that the entire surface of the carbon available in our composite material is accessible to energy storage. This assumed accessible surface area is referred to hereinafter as theoretical carbon surface area (expressed in m 2).

To store charge in a sample of the composite, a voltage source is applied to the external surface of the sample. The voltage difference between the voltage source and the electrically conductive network will drive charge from the source to the electrically conductive network. The electrolyte solution enables to transport the charge from the voltage source, through the non-electrically conductive porous material and to the distributed electrically conductive network therein. The electrically conductive network is able to store the transported charge using the surface porosity. Similarly, electrical charge is discharged from a sample by connecting a negative voltage source to the composite and the voltage difference will drive charge stored in the electrically conductive network, through the non-electrically conductive porous material via the electrolyte solution to the negative voltage source. It would be known to those skilled in the art that a variety of methods, means and systems can be used to control the charging, storage, and discharge of electrical charge on a capacitor. Embodiments of the invention are able to utilize any existing art for the charging, storage, and/or discharging of electrical charge in a conductive material. In some embodiments, a processor, or other computation device, may be utilized to control the connection of voltage sources (positive and negative) to the composite and the resulting charging, storage, and/or discharging of electrical charge. Additionally, any manner of conductive material may be utilized to connect voltage sources to a sample composite to improve/control the flow of electrical charge to and from the composite.

A supercapacitor can be constructed from samples comprising electrically conductive composites taught herein, separated by a dielectric porous medium permeable to electrolyte species. The constructed supercapacitor is able to function as both a medium for electrical charge storage and distribution as well as a structural or non-structural (e.g., mortar layer) element in a building or other structure. The dielectric porous medium may comprise a separator membrane comprising at least one of paper and Portland cement. Each of the conductive samples may comprise a sheet comprising the electrically conductive composite, the sheet being less than about 100 cm thick, such as less than about 10 cm thick. The structural supercapacitor may be in electrical connection with an energy source, such as at least one of a solar energy source, a wind power source, a biofuel energy source, a biomass energy source, a geothermal power source, a hydropower source, a tidal power source and a wave power source. The structural supercapacitor may be in electrical connection with a battery.

Example Sample Preparation

Example embodiments for methods for creating a structural supercapacitor use a method for creating an electron-conducting cement-carbon. This method is described in detail in U.S. application Ser. No. 16/245,752, now U.S. Pat. No. 10,875,809, the entire teachings of which are incorporated herein by reference. However, some embodiments do not require the addition of a dispersant in the chemical reactive mixture. The rational of not using a dispersant is two-fold: (i) it provides a baseline of a reference electron conductivity achieved with different nano-carbon black materials; (ii) this reference permits a direct comparison of different mix designs, excluding the positive or negative impact of a dispersant agent in the material. Alternatively, other embodiments of the invention include a dispersant agent and the invention will work with or without dispersant. In such embodiments, a “dispersing agent” is an agent that disperses a carbon phase including carbon particles, in water. For non-limiting example, carboxymethyl cellulose or a cellulose based polymer can be used.

In one, non-limiting example, first, cement and carbon powders are mixed using an overhead stirrer to create a dry mix. Water is then added under continuous stirring to obtain the target W/C ratio to create a cement/carbon paste. Alternatively, cement, carbon powders, water, and any other desired additive or aggregate may be added concurrently. The cement/carbon paste is then cast into a polycarbonate mold of 2.2 cm diameter, which define the geometric area (3.8 cm2) of electrodes comprised of the composite produced by a chemical reaction, e.g., hydration, of the created cement/carbon paste. Alternative embodiments of the invention can create electrodes of any desired shape or size. The samples are sealed with parafilm at both ends and immersed in a lime/water solution during the hydration process. During the hydration process, a chemical reaction will form a non-electrically conductive structural matrix, the hardened cement, that includes an electrically conductive network able to store charge, the carbon particles distributed throughout the structural matrix. Additionally, the porous nature of the non-electrically conductive structural matrix will create a transport porosity that connects, and provides access to, the distributed electrically conductive network.

Hardened samples are unmolded after at least 28 days, following the practice of concrete engineering. The electrodes are then cut from the hardened samples with a low-speed rotating saw to a specified thickness and the surface of the electrodes are then polished with a sequence of SiC papers of decreasing abrasiveness. The electrodes are then placed in an electrolyte solution which saturates the transport porosity of the non-electrically conductive structural matrix. In this specific non-limiting example embodiment, the electrolyte solution is a one molar solution of potassium chloride solution (KCl 1M). When the electrolyte solution saturates the transport porosity it connects and allows charge to flow to and from the electrically conductive percolated network. As used herein, “saturation” means filling a majority of the transport porosity, but does not require filling all of the transport porosity. A measurement device can then be used to record the charge storage capacity and dispersion rate of energy stored in the electrodes.

Other methods of manufacturing can be utilized to create the conductive composite and electrodes and supercapacitors comprised of thereof. In some embodiments, these methods may be additive manufacturing such as, but not limited to, 3-D printing.

Electrode Arrangement and Capacitance Measurements

The capacitance of example supercapacitor devices comprised of the cement composite are investigated by building upon conventional electrochemical cyclic voltammetry (CV) and applying galvanostatic charge-discharge (GCD) cycles. The maximum storage capacity can be experimentally assessed by combining CV test results with GDC test results.

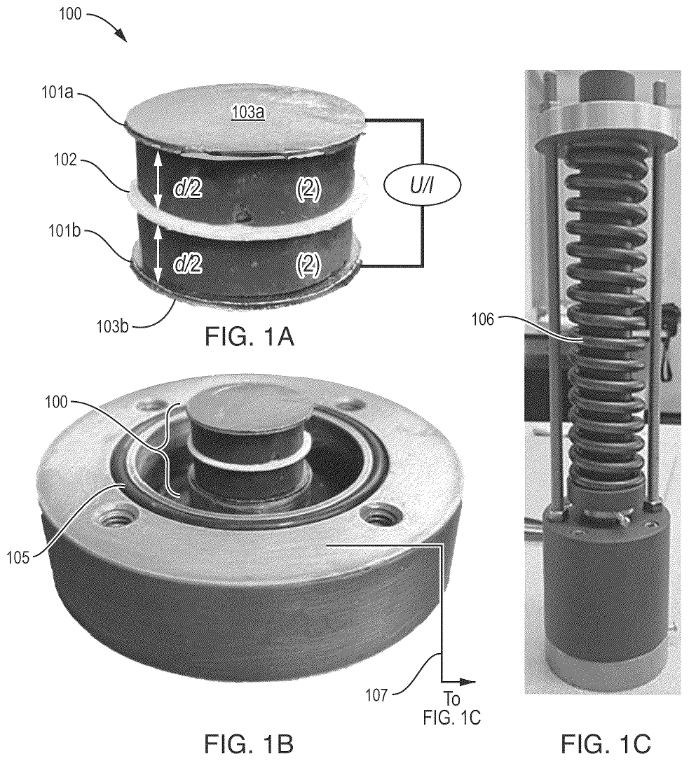

FIG. 1A is a sample 100 with a symmetrical arrangement of two electrodes 101a and 101b, comprised of a cement composite created by embodiments of the invention. While FIG. 1A only shows one possible geometric arrangement of electrodes 101a, and 101b, alternative embodiments of the invention may arrange electrodes in any desired numerical, geometric, and distribution arrangement, for non-limiting example, in series or in parallel, that enable the charging, storage, and discharge of electrical charge. Measurements of the samples were performed using two symmetric porous electrodes 101a and 101b (collectively 101) of thickness d made of the hardened carbon-cement composite separated by a glassy fiber separator 102 and arranged to form an electric double layer capacitor (EDLC) system. The separator 102 was also soak in the same electrolyte solution (KCl 1M) as the electrodes 101. The electrodes 101 were covered by conductive graphitic paper 103a and 103b (collectively 103) that served as current collector. The sample 100 was sealed using o-rings 105 in a closed cell 107, as shown in FIG. 1B, to avoid loss of electrolyte solution by evaporation during experimental measurements. FIG. 1B is a picture of a sample 100 symmetrical arrangement of two electrodes enclosed by o-rings 105.

FIG. 1C is a picture of a device 106 configured to apply pressure applied to a sample 100 symmetrical arrangement of two electrodes enclosed in closed cell 107 by o-rings 105. Using spring 106 and its supports, the entire sample 100 within closed cell 105 was pre-stressed with a force of 1,200 N to ensure a good contact between the different elements and thus minimize the occurrence of system resistance. They experimental setup shown in FIG. 1C enables the pressure on sample 100 to be controlled and be used for electrochemical measurements. With limited resistance, charge can flow freely within the electrodes 101, using the electrolyte solution within their transport porosity and to and from the electrically conductive network within the electrodes 101.

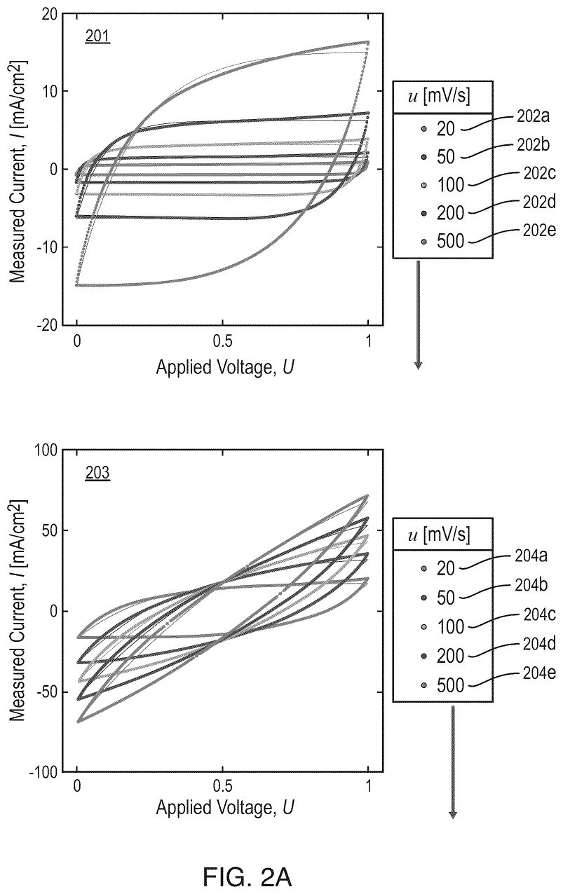

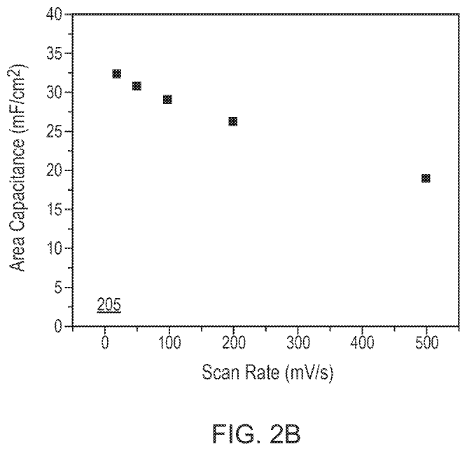

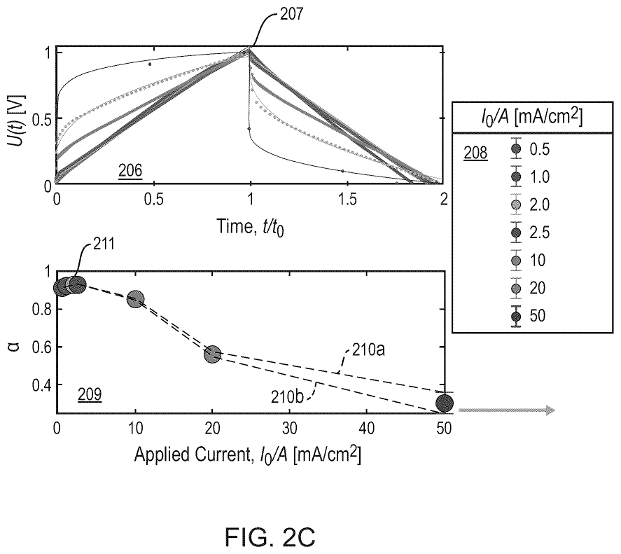

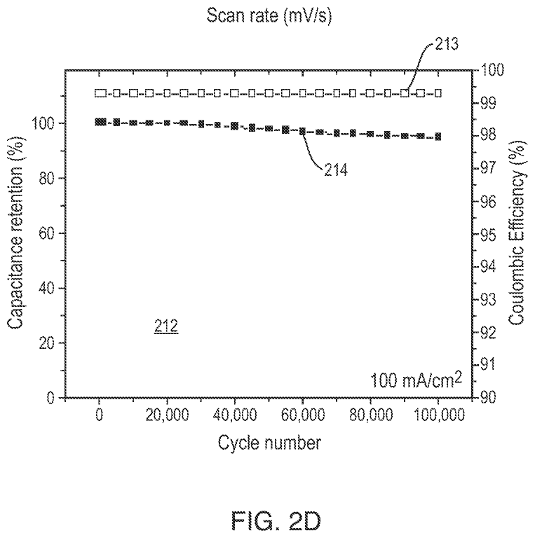

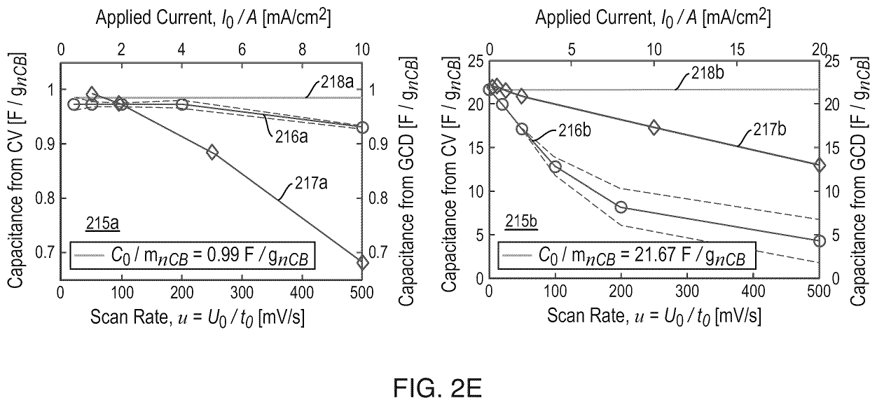

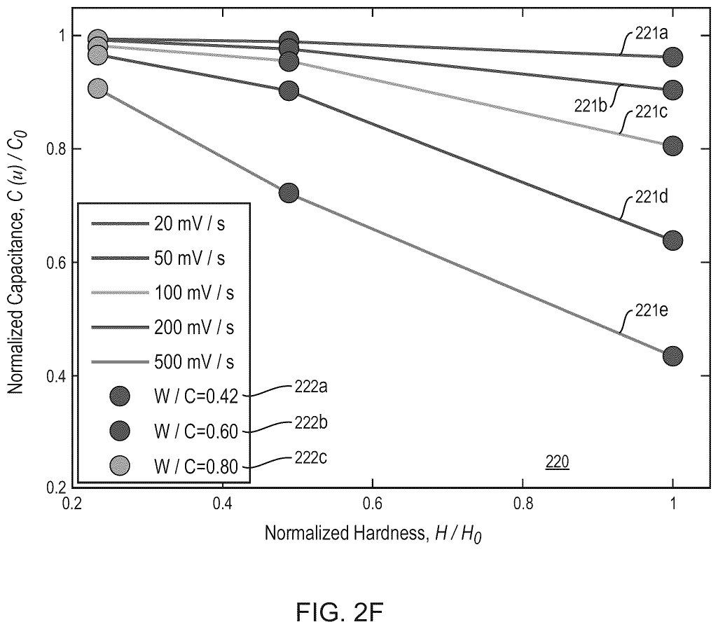

FIG. 2A is a set of graphs 201 203 of cyclic voltammetry (CV) curves 202a-e and 204a-e recorded at different prescribed scan rates for samples 100 symmetrical arrangement of two electrodes 101. Graph 201 shows the CV curves 202a-e for a sample comprised of the composite created by embodiments of the invention with a water-to-cement ratio of 0.8 utilizing PBX 22.4 carbon black particles and an electrode 101 thickness of 0.18 cm. Graph 203 shows the CV curves 204a-e for a sample comprised of the composite created by embodiments of the invention with a water-to-cement ratio of 1.4 utilizing Kejten black 12.8 carbon black particles and an electrode 101 thickness of 0.60 cm. The electrodes 101 are connected to an outside potential difference, charging one electrode with a positive charge, and the other with a negative charge, while a current I is measured. While the force is being applied, the electrodes 101 were charged and discharged on a voltage window from 0 to a max voltage (U₀) 1V with a constant scan rate (u=U₀/t₀) varying between 20 mV/s to 500 mV/s, the corresponding charge-discharge time thus ranging from 50s to 2s. Capacitance is the ratio of the change in the electric charge of a system, to the corresponding change in its electric potential. When testing the prepared samples, capacitance was measured from the discharge curve in the cyclic voltammetry (CV)-curves divided by the scan rate and the sweep potential window of 1V considering the symmetric arrangement of the electrodes 101 in sample 100.

FIG. 2B is a graph 205 of an areal capacitance determination as a function of the discharge rate for the sample's cyclic voltammetry (CV) curves 202a-e shown in FIG. 2A for the sample comprised of the composite created by embodiments of the invention with a water-to-cement ratio of 0.8. Graph 205 shows the results of the measured capacitance displayed in the form of a plot of areal capacitance vs. scan rate. Areal capacitance is equal to capacitance divided by the geometric electrode 101 area of the tested samples 100.

FIG. 2C shows the results of a galvanostatic charge-discharge (GCD) test on a sample symmetrical arrangement of two electrodes, comprised of the cement composite created by embodiments of the invention with a water-to-cement ratio of 0.8. A discharge current, over a discharge time Δt over sweep potential window permits a second determination of capacitance as disclosed by Roldán, S., Barreda, D., Granda, M., Menendez, R., Santamaria, R., & Blanco, C. (2015). An approach to classification and capacitance expressions in electrochemical capacitors technology. Physical Chemistry Chemical Physics, 17(2), 1084-1092. This second determination of capacitance is used to validate the capacitance determination from the cyclic voltammetry (CV) curves 201a-e displayed in graph 202 in FIG. 2B. More specifically, in the GCD test, a current, I₀, is applied and maintained constant in time until a target voltage, U(t=t₀)=1 V, is attained, at which state the current is reversed until the potential different is zero, U(t=t₀+t_{d})=0. Graph 206 shows the resulting curves 207 for applied current per area of electrodes 101, I₀/A, from 0.5 to 50 identified by color in key 208. Graph 209 is a graph of the value 211 of fractional exponent a for each value of I₀/A, shown in key 208 used for the GCD test. Error bars 210a, 210b represent one standard deviation for 500 cycles.

Finally, cyclic GCD measurements were carried out, where a sample 100 supercapacitor is charged and discharged for N cycles and the capacitance is determined after each cycle. FIG. 2D is a graph 204 of capacitance retention 206 and coulombic efficiency 205 during charge-discharge cycles a sample 100 symmetrical arrangement of two electrodes, comprised of a cement composite created by embodiments of the invention with a water-to-cement ratio of 0.8. The results, shown in graph 204 of the cyclic GCD-measurements permit determination of the capacitance retention, showing that there is little loss of capacitance over 100,000 cycles and thus the energy storage capacity, during cyclic loading of the electrodes 101 of sample 100.

Together, FIGS. 2A-D show that the electrically conductive sample 100, shown in FIG. 1A, and created using embodiments of the invention has the necessary properties to act both as a structural supporting material and an energy storage and distribution system.

Additionally, as detailed further below, the measurements taken in the CV and GCD tests can be used to extract the capacitance as a material property of the cement composite comprises the measured samples. A detailed calculation is required to correct for both rate effects in CV-tests or for the influence of current magnitude in GCD-tests. Both phenomena stem from the diffusion control of the change storage in a double-layer capacitor configuration, shown in FIG. 1A, and its impact on ion conductivity at the electrode scale and the scale of ion diffusion, dissociation, solvation, and charge storage. To address this, an approach is taken that is based on the consideration that if capacitance exists as a standalone electric property characterizing an EDLC, this capacitance should be independent of the experimental condition by which it is obtained. Once such a test-independent capacitance measure is available, it becomes possible to scale the rate capability of the electrodes comprised from the cement composite created by embodiments of the invention.

With this in mind, one can consider an equivalent R-C circuit in which a resistor, R, representative of all resistances present in the system 100, shown in FIG. 1A, is in series with a capacitor, C. The problem is framed in the context of Boltzmann's intergrodifferential equations. Following this approach, the current I can be linked to potential difference by means of the following convolution integral:

$$U ( t ) = {\int }_{- ∞}^{t} R ( t - {t}^{′} ) \frac{dI}{{dt}^{′}} {dt}^{′} \qquad Equation 1$$

where the kernel [symbol] (t−t′), is the time-dependent resistance function, accessible in a GCD test carried out at constant current I(t)=I₀. The versatility of this linear input/output response theory can be used to derive steady-state solutions for the cyclic testing for both the CV-curve and its integral representative area of the CV-hysteresis loop.

$$I = λ uC ( u ) ( 1 - \frac{2 ( 1 - exp ( - {\overline{t}}_{0} ) )}{1 - exp ( - 2 {\overline{t}}_{0} )} exp ( - λ \overline{{t}_{0}} Δ \overline{U} ) ) \qquad Equation 2$$

$$C ( u ) = \frac{∮ IdU}{2 u {U}_{0}} {( 1 - \frac{1}{{\overline{t}}_{0}} \frac{2 ( 1 - {exp ( - {\overline{t}}_{0} )}^{2}}{1 - exp ( - 2 {\overline{t}}_{0} )} )}^{- 1} \qquad Equation 3$$

where t̅₀=t₀/τ is the ratio of charge time, t₀, to the characteristic time of the double layer capacitor defined by τ=RC; whereas

$$Δ \overline{U} = \frac{U}{{U}_{0}} - ( 1 - λ ) / 2$$

stand for the dimensionless voltage difference prescribed during the charge (λ=+1) and discharge (λ=−1), respectively. Applied to the CV-test results displayed in graphs 201 and 203 of FIG. 2A, the output of this dual-fit for each scan right is the dependent capacitance C(u) of the material comprising the sample electrodes tested.

A similar calculation can be applied to the results of the GCD-tests, shown in graph 207 in FIG. 2C to extract capacitance from the recorded voltage history. However, there is one subtle difference, instead of an integer rate equation a fractional derivative is employed to capture the visible impact of high applied currents on the model response. That is, instead of Equation 1, the following fractional integral is applied:

$$U ( t ) = {U}^{+} + \frac{R {τ}^{α}}{{Γ}_{1 - α}} \int {( t - {t}^{′} )}^{- α} \frac{dI}{{dt}^{′}} {dt}^{′} \qquad Equation 4$$

where Γₓ=Γ(x) the complete Gamma function. Herein, U⁺ stands for the voltage after instantaneous charge or discharge, while the second term stands for the non-instantaneous part of the potential difference stored in the tested electrodes, defined by the fraction exponent, αε[0,1]. For a constant applied current, I(t)=I₀, integration of the fraction derivatives results in the below:

$$U ( t ) = {U}^{+} + λ \frac{R {I}_{0}}{{Γ}_{1 + α}} \{ \begin{matrix}{\overline{t}}^{α} & for 0 \leq t / {t}_{0} \leq 1 \\ {( \overline{t} - {\overline{t}}_{0} )}^{α ;} & for 1 \leq t / {t}_{0} \leq 2\end{matrix} \qquad Equation 5$$

with U⁺=U(t=0⁺)=RI₀ for charge (Δ=+1) and U⁺=U(t₀⁺)=RI₀t̅₀^{α}/Γ_{1+α} for discharge (λ=−1); while

$$\overline{t} = \frac{t}{τ}$$

is dimensionless time. From fitting the recorded GCD voltage for different applied currents, shown in graph 206 of FIG. 1C, the fractional exponent is found to converge to α=1 for low applied current, as shown in graph 211 of FIG. 1C, for which the capacitance is obtained from

$$C = \frac{{I}_{0} {t}_{d}}{U ( {t}_{0}^{+} )}$$

with t_{d} the discharge time, and U(t₀⁺) the measured voltage after instantaneous voltage drop at time t₀. This capacitance measurement is stable for at least n=10,000 charge discharge cycles in terms of both capacitance retention and Coulombic efficiency.

FIG. 2E is a set of graphs 215a, 215b showing the results of the capacitance per carbon black particle mass for two sets of electrodes comprised of the cement composite created by embodiments of the invention. Graph 215a shows the results of a sample with a water-to-cement ratio of 0.8 utilizing PBX 22.4 carbon black particles and an electrode 101 thickness of 0.18 cm, and its respective CV test results are shown in graph 201 of FIG. 2A. Graph 215b shows the CV curves 204a-e for a sample comprised of the composite created by embodiments of the invention with a water-to-cement ratio of 1.4 utilizing Kejten black 12.8 carbon black particles and an electrode 101 thickness of 0.60 cm, and its respective CV test results are shown in graph 203 of FIG. 2A. The results shown in FIG. 2E show that the model-based approach disclosed herein is able to translate CV-curves of measured samples into capacitance values, identified by lines 216a and 216b. Similarly, lines 217a and 217b show the capacitance values derived from the GCD tests of the respective samples. Each sample's capacitance per mass measurements coverage at different values identified by lines 218a and 218b. This difference is a hallmark of the versatility of the cement composite created by embodiments of the invention.

Thus, the two series of capacitance measurements, one from the CV-measurements 216a and 216b, the other from the GCD measurements 217a and 217b converge at respectively low scan rates in the CV-tests (u→0) and low current values in the GCD tests (I₀→0) to a single value, C₀. This is significant because the total power of a supercapacitor, P=IU, and the estimated energy, Eₜₒₜ=∫₍ₜ₎Pdt, includes both an instantaneous and non-instantaneous contribution; whereas the actual energy storage capacity in the example electrodes is the potential difference associated with only the non-instantaneous charge storage in the constructed EDLC system. The capacitance C₀ obtained by measuring and the correcting the CB and GCD measurements, shown in FIG. 2E, eliminates the instantaneous response, and can be viewed, as representative of the maximum (non-instantaneous) energy storage capacity of electrodes composed of the cement composite created by embodiments of the invention. This is quantified by the below equation:

$$max {E}_{t o t} = \frac{1}{2} {C}_{0} {U}_{0}^{2} ; {C}_{0} = {lim}_{u \to 0} C ( u ) ; {U}_{0} = {lim}_{{I}_{0} \to 0} U ( {t}_{0}^{+} ) \qquad Equation 6$$

That is, capacitance C₀, is a rate-independent electrode property independent of testing conditions, ion conductivity, and other factors. This scaling of capacitance C₀, with respect to the maximum energy storage permits evaluating the high-rate capabilities of cement composites created by embodiments of the invention for fast energy storage. Specifically, electrodes comprised of composites with high water-to-cement (W/C) ratios, which exhibit a large hydration porosity, approach the rate-independent capacitance even at high scan rates, and achieve close to maximum energy storage in the shortest time. In contrast, as the thickness of the electrodes is increased the rate capability diminishes requiring longer change times to realize the full energy storage potential of the electrode and their component cement composite material.

Moreover, normalized capacitance C(u)/C₀, enables the potential for forming structural electrodes of the created cement composite material to be identified. Specifically, for applications that focus on dual functionality, high-rate capability energy storage when a power source is applied and strength capacity to safely sustain mechanical load. High rate capability is achieved with high W/C-ratio electrodes which in turn reduces the cohesive strength of the materials, as determined by hardness measurements. However, the flexibility of the disclosed process herein used to create the cement composite material can be used to create a structural electrode with the desired tradeoff between capacitance, rate capability, and structural strength. The invention, by enabling the use of different types and amounts of carbon black particles and water to cement ratio provides multiple levers for which to control both the electrical and structural properties of the resulting material.

FIG. 2F is a graph 220 that shows the relationship between hardness and capacitance for electrodes composed of the cement composite created by embodiments of the invention. Graph 220 shows samples composed of composite materials with a range of Water to Cement ratios 222a-222c and their normalized capacitance for a range of scan rates 221a-221e. Graph 220 demonstrates the tradeoff available between high-rate capability and material strength.

Impact of Transport Porosity Due to Cement Hydration Process

One key element of the invention is that the capacitance of the created composite is controllable based upon the composition of the reactive mixture that generates it. More specifically, by altering the water-to-cement (or other non-conductive binder) ratio in the mixture, the transport porosity of the resulting composite, and therefore the capacitance can be modulated. To provide a proof of concept that the capacitance can be modulated through the cement-hydration porosity, the CV-curves of three specimens, prepared at different W/C ratios, 0.42, 0.6, and 0.8, corresponding to three different estimates of the transport porosity, ˜0%, 19%, and 34 vol % of the cement hydration products, were compared.

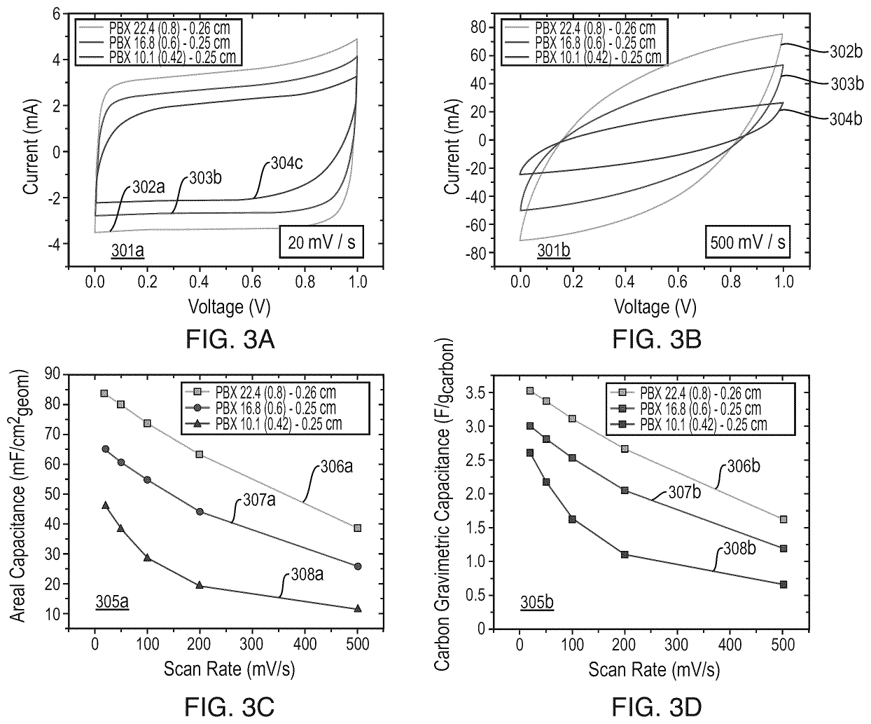

FIG. 3A is a graph 301a of cyclic voltammetry (CV) curves 302a, 303a, and 303a of three cement composites created by embodiments of the invention with water-to-cement ratios of 0.42, 0.6, and 0.8 at a scan rate of 20 mV/s. FIG. 3B is a graph 301b of cyclic voltammetry (CV) curves 302b, 303b, and 303b of three composites created by embodiments of the invention with water-to-cement ratios of 0.42, 0.6, and 0.8 at a scan rate of 500 mV/s. The area enclosed by the cyclic voltammetry (CV) curves grows as the water-to-cement, ratio and therefore the resulting transport porosity, increases.

FIG. 3C is a graph 305a of the derived capacitance values 306a, 307a, and 308a as a function of scan rate for three composites created by embodiments of the invention with water-to-cement ratios of 0.42, 0.6, and 0.8. The capacitance values 306a, 307a, and 308a was divided by the geometric area of the samples, 3.8 cm², to determine areal capacitance of the composites.

FIG. 3D is a graph 305b of the carbon gravimetric capacitance 306b, 307b, and 308c as a function of scan rate for three composites created by embodiments of the invention with water-to-cement ratios of 0.42, 0.6, and 0.8. The carbon gravimetric capacitance 306b, 307b is representative of the carbon-mass-specific capacitance, capacitance divided by the mass of the active carbon in the composite material. The carbon-mass-specific capacitance permits showing the level of efficiency of the active carbon in the composite electrodes, and corrects for any possible effect of the different carbon-to-cement mass ratios in the specimens. The percent of the total mass of the composite comprised of the conductive carbon particles varies from 10.1 mass % for the W/C=0.42 material, to 16.8% mass % for the W/C=0.6 material, and 22.4 mass % for the W/C=0.8 material. Alternative embodiments can have different mass percentage amounts of carbon dependent upon the water-to-cement ratio used.

The results shown in FIGS. 3C and 3D provide clear evidence that the fine tuning of the transport porosity using the tools of cement engineering (i.e., mix design with chosen water-to-cement ratio) provides a means to increase the capacitance of the cement-carbon composite irrespective of scan rate. This confirms that the residual porosity (“cement porosity” or “transport porosity”) left by the hydration of the mineral precursor (cement) provides the necessary pathway for the electrolyte to be transported to the active porosity (“storage porosity”) of the carbon material in a more efficient manner, therefore providing a means to optimize the rate capability of the cement/carbon supercapacitors.

Impact of Carbon-Black Storage Porosity

The second lever embodiments of the invention used to control the properties of the created composite is the specific surface of the carbon black, a surface along which at the interface between electrolyte and the carbon surface electrical charge is stored. This surface can be increased by the porosity (“storage porosity”) of the carbon particles used. To show the impact, the capacitance of three samples are compared, the samples prepared with different types of carbon black, PBX 55, Vulcan, and KetjenBlack, the properties of which are listed above in Table 1. However, embodiments of the invention are able to utilize any type of carbon, or other conductive, particle that can form electrically conductive network and store charge.

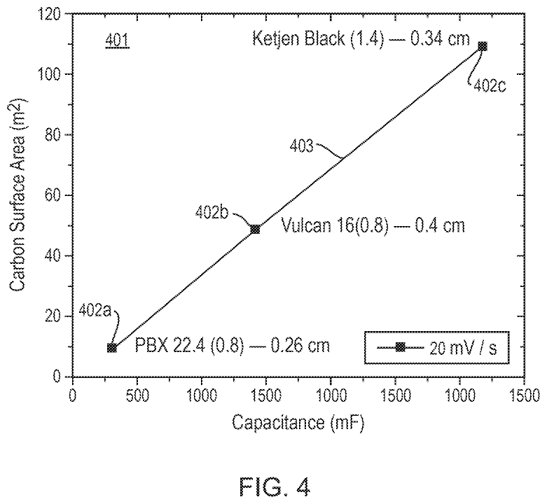

FIG. 4 is a graph 401 of the capacitance as a function of carbon surface area of three sample cement composites created by embodiments of the invention utilizing different carbon particles. The capacitance measurements were obtained from CV-curves at a 20 mV/s scan rate. A first sample 402a was created using PBX 55 as the carbon particles. A second sample 402b was created using Vulcan 55 as the carbon particles. A third sample 402c was created using Ketj en Black as the carbon particles. The first and second samples 402a, 402b utilized a water-to-cement ratio of 0.8. The third sample utilized a water-to-cement ratio of 1.4. The carbon surface area herein was determined from the BET specific surface area (listed in Tab. 1) multiplied by the mass of carbon black in the sample electrodes. The positive correlation, shown by trend line 403, between the two quantities provides strong evidence that the active porosity (storage porosity) in the carbon phase in the carbon-cement composite both increases in capacitance with an increase in specific surface but also that that this active porosity is fully accessible to the electrolyte saturating the cement porosity (transport porosity).

A detailed experimental analysis and quantification of the porosity and spatial correlation of samples prepared using embodiments of the invention using Raman spectroscopy data is set out in the publication N. Chanut, D. Stefaniuk, J. C. Weaver, Y. Zhu, Y. Shao-Horn, A. Masic, and F.-J. Ulm, “Carbon—cement supercapacitors as a scalable bulk energy storage solution”, PROCEEDINGS OF THE NATIONAL ACADEMY OF SCIENCES, Vol. 120, No. 32, Aug. 8, 2023, which is incorporated in its entirety herein by reference.

Scaling of Energy Storage Capacity

Embodiments of the invention may be used to create and/or manufacture massive energy storage in structural carbon-cement supercapacitor systems. To scale up such large systems, scalability of the electrode system composed of the created cement composite material is needed. Such a scaling can be enabled when (1) the rate-independent capacitance can be reduced to an intensive quantity, whose magnitude is independent of the size of the system, while (2) providing a measure for the high-rate capability as a function of electrode dimensions and constituent properties. The first challenge is addressed by Equation 6 which provides means of a dimensional analysis of the asymptotic state of maximum energy storage. In this asymptotic state, the surface of the carbon black particles can be considered to be entirely surrounded by an oppositely charged surface layer of ions. It follows from a dimensional analysis that the rate-independent capacitance values of eight samples composed of cement composite material created using embodiment of the invention.

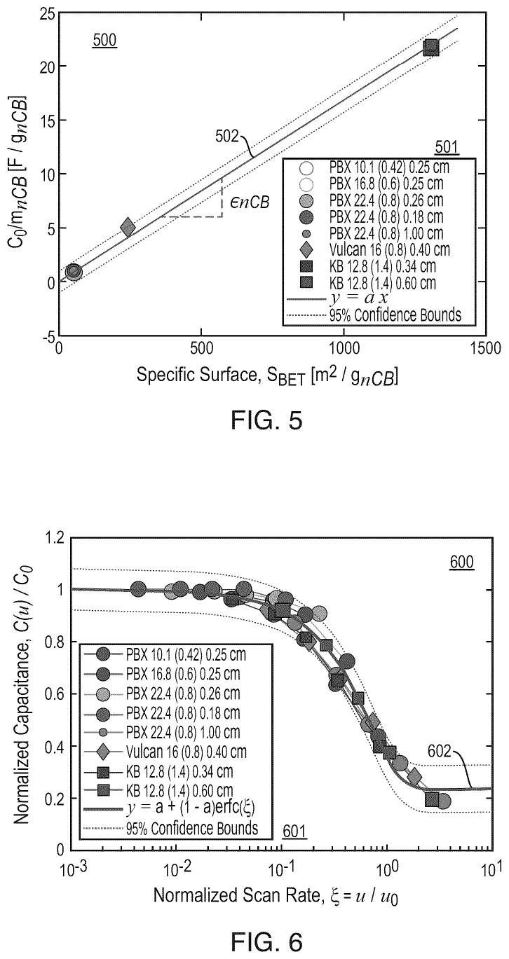

FIG. 5 is a graph 500 of the rate-independent capacitance of eight different electrodes comprised of cement material, created using embodiments of the invention, showing the intensive nature of the energy storage capacity of created electrode systems. Key 501 identifies the properties of the cement material which includes, in order, the type of carbon black particles, the water to cement ratio, and the thickness of the electrodes. The x-axis of graph 500 denotes the specific surface area of the carbon black parties, S BET which ranged from 52,241 to 1307 m²/g. The materials were also prepared using different carbon concentrations, ϕ_{cpc} between 0.71 and 0.179 g/cm³. As shown by trend line 502 these properties can be reduced to a linear scaling of the rate-independent specific capacitance:

$$\frac{{C}_{0}}{d A ϕ c ρ c} = {ϵ}_{nCB} {S}_{BET} \qquad Equation 7$$

with ∈_{nCB}=1.68×10⁻² F/m² (with a 95% confidence interval) being the fitted aerial capacitance of carbon black. This scaling corroborates the intensive nature of the energy storage capacity of electrode systems composed of cement materials created using embodiments of the invention.

A similar calculation can be done for rate capability, by considering a scaling of the scan rate, u=ξu₀, to achieve a single dimensionless relation, C(u)/C₀=F(ξ). From the asymptotic solution shown in Equation 7, it is retained that the energy storage capacity is an absorption process of charged ions and we can adopt ξ for the classical dimensionless diffusion variable ξ=d₂/(Dt₀). For diffusivity D, texture analysis is used, recognized that the tortuosity of the ion diffusion path through the hydration porosity is mediated by the chord length ratio of the texture,

$$\frac{{l}_{CB}}{{l}_{LD / HD}} ∼ ϕ c ρ {cS}_{BET} / {s}_{LD / HD} ) ,$$

with s_{LD/HD} the texture specific surface. This enables the collapsing all test result onto a single master curve:

$$ξ = \frac{{d}^{2} ϕ c ρ {cS}_{BET}}{{s}_{L D} {t}_{0} γ {D}_{0}} {( \frac{W}{C} )}^{- 3} \qquad Equation 8$$

FIG. 6 is a graph 600 of the rate dependent capacitance of eight different electrodes comprised of cement material created using embodiments of the invention scaled along the horizontal axis by means of the classical dimensionless diffusion variable. The properties of the materials used to create the electrodes is set out in key 601. As shown by Equation 8, all electrodes, are clustered around a single curve 602. The curve is approximated by a complementary error function of the form C(u)/C₀=a+(1−a)erfc(ξ), with γD₀=6.654×10⁻⁴ m²/s (with 95% confidence interval) being a fitted diffusion coefficient and a=0.234 being an asymptotic value for ξ»1. The self-similar nature of the scaling relation is of great interest to evaluate the high-rate capability of carbon-cement electrodes. For example, for ξ<0.1, the electrodes exhibit a high-rate capacitance, C(u)/C₀>0.91±0.05, whereas for ξ>1, the capacitance drops below C(u)/C₀<0.35±0.05. Therefore, the scaling relationships shown in Equations 7 and 8 and demonstrated in FIGS. 5 and 6 provide means to fine-tune the material design of the carbon-cement composite for specific applications.

The material design of the created porous carbon-cement composite provides a scalable material solution for energy storage to support the transition from fossil fuels to renewable energies. The key to scalability is the intensive nature of the volumetric capacitance, which originates from the unique texture of the space filling carbon network. This intensive nature can enable a mass scaling of the energy storage capacity density,

$$\frac{max {E}_{tot}}{V} = ( \frac{1}{2 V} ) {C}_{0} {U}_{0}^{2} \approx 20 - 220 Wh / {m}^{3} ,$$

depending on the specific surface area of the carbon black utilized, from electrode to structural scales of volume V. For example, 45 m³ of a cement composite created by an embodiment of the invention, containing a high specific surface area would satisfy the average daily residential energy consumption of approximately 10 kWh. Embodiments of the invention could be used to enable multifunctional design of sustainable structures that leverage high energy storage capacity, high rate charge/discharge capability related to ion diffusion, and structural strength, for applications ranging from energy autarkic shelters, self-charging roads for electric vehicles, to intermittent energy storage for wind turbines and tidal power stations.

Embodiments of the disclosed invention makes use of the composite nature of cement-carbon materials to synthesize high-rate capability supercapacitors. This is enabled by a combination of (1) the cement porosity (transport porosity) as a result of the hydration process of the mineral pre-cursor; and (2) the high-specific surface of the carbon phase forming an electron conducting network. As proof of concept, it was disclosed how to synergistically synthesize high-rate capability supercapacitors making use of the water-to-cement mass ratio in combination with high specific surface area carbon black phases. Additionally, it was disclosed how to control the capacitance and charge/discharge rate of the synthesized supercapacitors during the creation of the composite material by controlling its transport porosity, by altering the water-to-cement ratio, and its storage porosity, by altering carbon surface area. Alternative embodiments are able to use other means of generating such porosity in cement-based materials (for instance, use of air-entrainment agents).

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A structural supercapacitor, comprising:
a composite composed of i) an electrically conductive percolated network hosting a porosity for charge storage and ii) a non-electrically conductive structural matrix, the non-electrically conductive structural matrix having a controlled transport porosity configured to host an electrolyte solution.

2. The structural supercapacitor of claim 1 wherein the composite is a product of chemical reactions of a chemically reactive mixture and wherein the controlled transport porosity is a function of an amount of a fluid in the chemically reactive mixture.

3. The structural supercapacitor of claim 2 wherein the fluid is a water-based solution.

4. The structural supercapacitor of claim 2 wherein an amount of the fluid in the chemically reactive mixture exceeds a level of the fluid required for formation of the non-electrically conductive structural matrix.

5. The structural supercapacitor of claim 1 wherein the composite further includes an electrolyte solution within the controlled transport porosity at a level of saturation.

6. The structural supercapacitor of claim 1 wherein the composite is an electrically conductive cement composite.

7. The structural supercapacitor of claim 1 further comprising at least one of sand, gravel, stones or other conductive or non-conductive aggregates mixed with the composite.

8. The structural supercapacitor of claim 1 being produced by additive manufacturing.

9. The structural supercapacitor of claim 1 wherein the electrically conductive percolated network hosting a porosity includes porous electrically conductive particles.

10. The structural supercapacitor of claim 9 wherein the porous electrically conductive particles are selected from a group having an accessible specific surface, including: carbon black nanoparticles, activated carbon, carbon nanotubes, mXene, a metal-organic framework, or a mixture of electrically-conductive particles.

11. The structural supercapacitor of claim 1 further comprising a non-conductive separator separating a first electrode structure and a second electrode structure, the first and second electrode structures defined by the composite, the first and second electrode structures enabling storage and retrieval of energy to and from the structural supercapacitor.

12. The structural supercapacitor of claim 11 wherein the first and second electrode structure are oriented in an arrangement configured for use to charge/discharge energy into/out of structural and/or non-structural elements in buildings, road and transportation infrastructure, foundations and other underground structures.

13. A method of manufacturing a structural supercapacitor, the method comprising:
creating a chemically reactive mixture including a non-conductive binder, porous electrically conductive particles, and fluid; and
producing, by means of chemical reactions of the chemically reactive mixture, a composite that includes an electrically conductive percolated network hosting a porosity for charge storage and a non-electrically conductive structural matrix, the non-electrically conductive structural matrix having a controlled transport porosity configured to host an electrolyte solution.

14. The method of claim 13 wherein producing the composite includes controlling an amount of fluid applied to the chemically reactive mixture to create the controlled transport porosity.

15. The method of claim 14 wherein controlling the amount of the fluid in the chemically reactive mixture includes adding an amount that exceeds a level that is required for formation of the non-electrically conductive structural matrix.

16. The method of claim 14 wherein an electrical charge/discharge rate of the composite is dependent upon the controlled transport porosity.

17. The method of claim 13 further comprising saturating the controlled transport porosity with the electrolyte solution to produce a saturated electrolyte solution.

18. The method of claim 17 wherein the saturated electrolyte solution is in contact with the electrically conductive percolated network.

19. The method of claim 13 wherein the fluid is a water-based solution.

20. The method of claim 13 wherein the non-conductive binder is hydraulic cement.

21. The method of claim 13 wherein the non-conductive binder includes supplementary cementitious materials (SCM) selected from a group consisting of: fly ash, silica fume, slags, and other soluble siliceous, aluminosiliceous, or calcium aluminosiliceous powders used as partial replacements of clinker in cements or as partial replacements of Portland cement in concrete mixtures; and superplasticizers.

22. The method of claim 13 wherein the porous electrically-conductive particles are selected from a group having an accessible specific surface, the group consisting of: carbon black nanoparticles, activated carbon, carbon nanotubes, mXene, a metal-organic framework, or a mix of electrically-conductive particles.

23. The method of claim 13 wherein the non-conductive binder and the conductive particles constitute a dry mix, and further including mixing the dry mix with and an amount of fluid that controls the transport porosity.

24. The method of claim 13 wherein the non-electrically conductive structural matrix is configured to support a mechanical load.

25. The method of claim 13 further comprising forming a supercapacitor having a first electrode structure and a second electrode structure, the first and second electrode structures including the composite and separated by a non-conductive separator, the supercapacitor configured to provide a means of storing and retrieving energy via the first and the second electrode structures.

26. A chemically reactive mixture, the mixture comprising:
a non-conductive binder and porous electrically conductive particles; and
the mixture configured to produce, by means of chemical reactions induced by the addition of a fluid, a composite that includes an electrically conductive percolated network hosting a porosity for charge storage and a non-electrically conductive structural matrix, the non-electrically conductive structural matrix having a controlled transport porosity configured to host an electrolyte solution.

27. A method of storing electrical charge using a structural supercapacitor, the method comprising:
receiving, from a source external to a composite, electrical charge by an electrolyte solution, the electrolyte solution hosted in a controlled transport porosity of a non-electrically conductive structural matrix of the composite;
transferring, from the electrolyte solution, the received electrical charge to an electrically conductive percolated network hosting a porosity for charge storage within the composite; and
storing the electrical charge in the porosity for charge storage.

28. A method of discharging electrical charge using a structural supercapacitor, the method comprising:
transferring electrical charge stored in a porosity for charge storage hosted by an electrically conductive percolated network within a composite;
receiving the transferred electrical charge by an electrolyte solution, the electrolyte solution hosted in a controlled transport porosity of a non-electrically conductive structural matrix of a composite; and
discharging, from the electrolyte solution, the electrical charge to a receiver external to the composite.
